(19) United States
(12) Patent Application Publication
(10) Pub. No.: US 2013/0010706 A1
(43) Pub. Date: Jan. 10, 2013

(54) Uplink Power Control Adjustment State In Discontinuos Data Transfer

(75) Inventors: Petteri K. Kela, Kaarina (FI); Tommi T. Kangassuo, Salo (FI); Petteri M. Heinonen, Aura KK (FI); Jonathan M. Keast, Salo (FI)

(73) Assignee: Renesas Mobile Corporation

(21) Appl. No.: 13/178,808

(22) Filed: Jul. 8, 2011

(51) Int. Cl. H04W 24/00; H04W 52/04; H04W 72/04

(52) U.S. Cl. 370/329; 370/338

(57) ABSTRACT

The present invention provides a method, apparatus and a computer program product for uplink transmission power control in discontinuous data transfer. The present invention includes calculating, on a processor at a user equipment, a transmission power based on currently used bandwidth, and checking, on the processor at the user equipment, whether a transmission power limit has been reached based on the calculated transmission power.

### TECHNICAL FIELD

The present application relates generally to an apparatus and method and a computer program product for uplink transmission power control in discontinuous data transfer.

The UE calculates its uplink transmission power and the eNodeB can adjust the UEs transmission power by sending Transmission Power Control (TPC) commands that accumulate to the power control adjustment state used in the calculation. The present invention changes the behavior of the power control adjustment state.

### BACKGROUND

The following meanings for the abbreviations used in this specification apply:
3GPP The 3^{rd} Generation Partnership Project
BS Base Station
CRC Cyclic Redundancy Check
DCI Downlink Control Information
E-UTRAN Evolved Universal Terrestrial Radio Access Network̂#
PUCCH Physical Uplink Control Channel
PUSCH Physical Uplink Shared Channel
PDCCH Physical Downlink Control Channel
SRS Sounding Reference Symbol
RNTI Radio Network Temporary Identity
TPC Transmission Power Control
UE User Equipment

According to document [1], the setting of the UE Transmit power P_{PUSCH} for the physical uplink shared channel (PUSCH) transmission in subframe i is defined by

P_{PUSCH}=min{P_{CMAX}, 10 log₁₀(M_{PUSCH}(i))+P_{O}_{_{—}}_{PUSCH}(j)+α(j)·PL+Δ_{TF}(i)+f(i)} [dBm]

where,
P_{CMAX} is the configured UE transmitted power.
M_{PUSCH}(i) is the bandwidth of the PUSCH resource assignment expressed in number of resource blocks valid for subframe i.
P_{O}_{_{PUSCH}}(j) is a parameter composed of the sum of a cell specific nominal component P_{O}_{_{—}}_{NOMINAL}_{_{—}}_{PUSCH}(j) provided from higher layers for j=0 and 1 and a UE specific component P_{O}_{_{—}}_{UE}_{_{—}}_{PUSCH}(j) provided by higher layers for j=0 and 1. For PUSCH (re)transmissions corresponding to a semi-persistent grant then j=0, for PUSCH (re)transmissions corresponding to a dynamic scheduled grant then j=1 and for PUSCH (re)transmissions corresponding to the random access response grant then j=2. P_{O}_{_{—}}_{UE}_{_{—}}_{PUSCH}(2)=0 and P_{O}_{_{—}}_{NOMINAL}_{_{—}}_{PUSCH}(2)=P_{O}_{_{—}}_{PRE}+Δ_{PREAMBLE}_{_{—}}_{Msg3}, where the parameter PREAMBLE_INITIAL_RECEIVED_TARGET_POWER (P_{O}_{_{—}}_{PRE}) and Δ_{PREAMBLE}_{_{—}}_{Msg3} are signalled from higher layers.
For j=0 or 1, α∈{0, 0.4, 0.5, 0.6, 0.7, 0.8, 0.9, 1} is a 3-bit cell specific parameter provided by higher layers. For j=2, α(j)=1.
PL is the downlink pathloss estimate calculated in the UE in dB and PL=referenceSignalPower−higher layer filtered RSRP, where referenceSignalPower is provided by higher layers.
Δ_{TF}(i)=10 log₁₀((2^{MPR·K}^{ₛ}−1)β_{offset}^{PUSCH}) for K_{S}=1.25 and 0 for K_{S}=0 where K_{S} is given by the UE specific parameter deltaMCS-Enabled provided by higher layers
   MPR=O_{CQI}/N_{RE} for control data sent via PUSCH without UL-SCH data and

$${\sum }_{r = 0}^{C - 1} {K}_{r} / {N}_{RE}$$

for other cases.
where C is the number of code blocks, Kᵣ is the size for code block r, O_{CQI} is the number of CQI bits including CRC bits and N_{RE} the number of resource elements determined as N_{RE}=M_{sc}^{PUSCH-initial}·N_{symb}^{PUSCH-initial}.
β_{offset}^{PUSCH}=β_{offset}^{CQI} for control data sent via PUSCH without UL-SCH data and 1 for other cases.
δ_{PUSCH} is a UE specific correction value, also referred to as a TPC command and is included in PDCCH with DCI format 0 or jointly coded with other TPC commands in PDCCH with DCI format 3/3A whose CRC parity bits are scrambled with TPC-PUSCH-RNTI. The current PUSCH power control adjustment state is given by f(i) which is defined by:
   f(i)=f(i−1)+δ_{PUSCH}(i−K_{PUSCH}) if accumulation is enabled based on the UE-specific parameter Accumulation-enabled provided by higher layers or if the TPC command δ_{PUSCH} is included in a PDCCH with DCI format 0 where the CRC is scrambled by the Temporary C-RNTI
      where δ_{PUSCH}(i−K_{PUSCH}) was signalled on PDCCH with DCI format 0 or 3/3A on subframe i−K_{PUSCH} and where f(0) is the first value after reset of accumulation.
      The value of K_{PUSCH} is
         For FDD,K_{PUSCH}=4
         For TDD UL/DL configurations 1-6, K_{PUSCH} is given in Table 5.1.1.1-1 in document [1].
         For TDD UL/DL configuration 0
         If the PUSCH transmission in subframe 2 or 7 is scheduled with a PDCCH of DCI format 0 in which the LSB of the UL index is set to 1, K_{PUSCH}=7
         For all other PUSCH transmissions, K_{PUSCH} is given in Table 5.1.1.1-1 in document [1].
      The UE attempts to decode a PDCCH of DCI format 0 with the UE's C-RNTI or SPS C-RNTI and a PDCCH of DCI format 3/3A with this UE's TPC-PUSCH-RNTI in every subframe except when in DRX
      If DCI format 0 and DCI format 3/3A are both detected in the same subframe, then the UE shall use the δ_{PUSCH} provided in DCI format 0.
      δ_{PUSCH}=0 dB for a subframe where no TPC command is decoded or where DRX occurs or i is not an uplink subframe in TDD.
      The δ_{PUSCH} dB accumulated values signalled on PDCCH with DCI format 0 are given in Table 5.1.1.1-2 in document [1]. If the PDCCH with DCI format 0 is validated as a SPS activation or release PDCCH, then δ_{PUSCH is} 0 dB.
      The δ_{PUSCH} dB accumulated values signalled on PDCCH with DCI format 3/3A are one of SET1 given in Table 5.1.1.1-2 in document [1] or SET2 given in Table 5.1.1.1-3 in document [1] as determined by the parameter TPC-Index provided by higher layers.
      If UE has reached maximum power, positive TPC commands shall not be accumulated
      If UE has reached minimum power, negative TPC commands shall not be accumulated
      UE shall reset accumulation
         when P_{O}_{_{—}}_{UE}_{_{—}}_{PUSCH} value is changed by higher layers
         when the UE receives random access response message
   f(i)=δ_{PUSCH}(i−K_{PUSCH}) if accumulation is not enabled based on the UE-specific parameter Accumulation-enabled provided by higher layers
      where δ_{PUSCH}(i−K_{PUSCH}) was signalled on PDCCH with DCI format 0 on subframe i−K_{PUSCH}
      The value of K_{PUSCH} is
         For FDD, K_{PUSCH}=4
         For TDD UL/DL configurations 1-6, K_{PUSCH} is given in Table 5.1.1.1-1 in document [1].
         For. TDD UL/DL configuration 0
         If the PUSCH transmission in subframe 2 or 7 is scheduled with a PDCCH of DCI format 0 in which the LSB of the UL index is set to 1, K_{PUSCH}=7
         For all other PUSCH transmissions, K_{PUSCH} is given in Table 5.1.1.1-1 in document [1].
      The δ_{PUSCH} dB absolute values signalled on PDCCH with DCI format 0 are given in Table 5.1.1.1-2 in document [1]. If the PDCCH with DCI format 0 is validated as a SPS activation or release PDCCH, then δ_{PUSCH} is 0 dB.
      f(i)=f(i−1) for a subframe where no PDCCH with DCI format 0 is decoded or where DRX occurs or i is not an uplink subframe in TDD.
   For both types of f(*) (accumulation or current absolute) the first value is set as follows:
      If P_{O}_{_{—}}_{UE}_{_{—}}_{PUSCH} value is changed by higher layers,
         f(0)=0
      Else
         f(0)=ΔPᵣₐₘₚᵤₚ+δ_{msg2}
         where δ_{msg2} is the TPC command indicated in the random access response, and
         ΔPᵣₐₘₚᵤₚ is provided by higher layers and corresponds to the total power ramp-up from the first to the last preamble.

As described above, f(i) is the current power control adjustment state accumulated from received TPC commands.

Also, as described above, there are limitations in E-UTRAN if the UE has reached a maximum or a minimum power. In particular, TPC commands shall not be accumulated to the current power control adjustment state in certain situations. Namely,
If UE has reached maximum power, positive TPC commands shall not be accumulated; and
If UE has reached minimum power, negative TPC commands shall not be accumulated.

In practice, this means that f(i) is not accumulated with TPC command, if the output power calculation has reached the upper or lower limit with the previous power control adjustment state f(i−1).

In order to calculate the UE Transmit power, the parameter M_{PUSCH}(i) is needed, which is a resource allocation dependent parameter. As mentioned above, M_{PUSCH}(i) is the bandwidth of the PUSCH resource assignment expressed in number of resource blocks valid for subframe i.

In a similar manner, according to document [1], the setting of the UE Transmit power P_{PUCCH} for the physical uplink control channel (PUCCH) transmission in subframe i is defined by

P_{PUCCH}(i)=min{P_{CMAX}, P₀_{_{—}}_{PUCCH}PL +h(n_{CQI},n_{HARQ})+ΔF_{_{—}}_{PUCCH}(F)+g(i)} [dBm]

where
P_{CMAX} is the configured UE transmitted power.
The parameter Δ_{F}_{_{—}}_{PUCCH}(F) is provided by higher layers. Each Δ_{F}_{_{—}}_{PUCCH}(F) value corresponds to a PUCCH format (F) relative to PUCCH format 1a, where each PUCCH format (F) is defined in Table 5.4-1 [3].
h(n_{CQI},n_{HARQ}) is a PUCCH format dependent value, where n_{CQI} corresponds to the number of information bits for the channel quality information and n_{HARQ} is the number of HARQ bits.
   For PUCCH format 1,1a and 1b h(n_{CQI},n_{HARQ})=0
   For PUCCH format 2, 2a, 2b and normal cyclic prefix

$$h ( {n}_{CQI} , {n}_{HARQ} ) = \{ \begin{matrix}10 {log}_{10} ( \frac{{n}_{CQI}}{4} ) & if {n}_{CQI} \geq 4 \\ 0 & otherwise\end{matrix}$$

For PUCCH format 2 and extended cyclic prefix

$$h ( {n}_{CQI} , {n}_{HARQ} ) = \{ \begin{matrix}10 {log}_{10} ( \frac{{n}_{CQI} + {n}_{HARQ}}{4} ) & if {n}_{CQI} + {n}_{HARQ} \geq 4 \\ 0 & otherwise\end{matrix}$$

P_{O}_{_{—}}_{PUCCH} is a parameter composed of the sum of a cell specific parameter P_{O}_{_{—}}_{NOMINAL}_{_{—}}_{PUCCH} provided by higher layers and a UE specific component P_{O}_{_{—}}_{UE}_{_{—}}_{PUCCH} provided by higher layers.
δ_{PUCCH} is a UE specific correction value, also referred to as a TPC command, included in a PDCCH with DCI format 1A/1B/1D/1/2A/2/2B or sent jointly coded with other UE specific PUCCH correction values on a PDCCH with DCI format 3/3A whose CRC parity bits are scrambled with TPC-PUCCH-RNTI.
   The UE attempts to decode a PDCCH of DCI format 3/3A with the UE's TPC-PUCCH-RNTI and one or several PDCCHs of DCI format 1A/1B/1D/1/2A/2/2B with the UE's C-RNTI or SPS C-RNTI on every subframe except when in DRX.
   If the UE decodes a PDCCH with DCI format 1A/1B/1D/1/2A/2/2B and the corresponding detected RNTI equals the C-RNTI or SPS C-RNTI of the UE, the UE shall use the δ_{PUCCH} provided in that PDCCH.
   else
      if the UE decodes a PDCCH with DCI format 3/3A, the UE shall use the δ_{PUCCH} provided in that PDCCH
      else the UE shall set δ_{PUCCH}=0 dB.

$$g ( i ) = g ( i - 1 ) + {\sum }_{m = 0}^{M - 1} {δ}_{PUCCH} ( i - {k}_{m} )$$

where g(i) is the current PUCCH power control adjustment state and where g(0) is the first value after reset.
For FDD, M=1 and k₀=4.
For TDD, values of M and kₘ are given in Table 10.1-1 of document [1].
The δ_{PUCCH} dB values signalled on PDCCH with DCI format 1A/1B/1D/1/2A/2/2B are given in Table 5.1.2.1-1. If the PDCCH with DCI format 1/1A/2/2A/2B is validated as an SPS activation PDCCH, or the PDCCH with DCI format 1A is validated as an SPS release PDCCH, then δ_{PUCCH} is 0 dB.
The δ_{PUCCH} dB values signalled on PDCCH with DCI format 3/3A are given in Table 5.1.2.1-1 or in Table 5.1.2.1-2 of document [1] as semi-statically configured by higher layers.
If P_{O}_{_{—}}_{UE}_{_{—}}_{PUCCH} value is changed by higher layers,
   g(0)=0
Else
   g(0)=ΔPᵣₐₘₚᵤₚ+δ_{msg2}
   where δ_{msg2} is the TPC command indicated in the random access response, and
   ΔPᵣₐₘₚᵤₚ is the total power ramp-up from the first to the last preamble provided by higher layers.
If UE has reached maximum power, positive TPC commands shall not be accumulated.
If UE has reached minimum power, negative TPC commands shall not be accumulated.
UE shall reset accumulation
   when P_{O}_{_{—}}_{UE}_{_{—}}_{PUCCH} value is changed by higher layers
   when the UE receives a random access response message
g(i)=g(i−1) if i is not an uplink subframe in TDD.

The network may send TPC commands for PUCCH in DCI format 3/3A even if there is no PUCCH transmissions occurring. In order to check if maximum or minimum PUCCH transmission power has been reached according to document [1], h(n_{CQI},n_{HARQ})+Δ_{F}_{_{—}}_{PUCCH}(F) is needed.

Further, according to document [1], the setting of the UE Transmit power P_{SRS} for the Sounding Reference Symbol transmitted on subframe i is defined by

P_{SRS}(i)=min{P_{CMAX}, P_{SRS}_{_{—}}_{OFFSET}+10 log₁₀(M_{SRS})+P_{O}_{_{—}}_{PUSCH}(j)+α(j)·PL+f(i)} [dBm]

where
P_{CMAX} is the configured UE transmitted power.
For K_{S}=1.25, P_{SRS}_{_{—}}_{OFFSET} is a 4-bit UE specific parameter semi-statically configured by higher layers with 1 dB step size in the range [−3, 12] dB.
For K_{S}=0, P_{SRS}_{_{—}}_{OFFSET} is a 4-bit UE specific parameter semi-statically configured by higher layers with 1.5 dB step size in the range [−10.5,12] dB
M_{SRS} is the bandwidth of the SRS transmission in subframe expressed in number of resource blocks.
f(i) is the current power control adjustment state for the PUSCH, as described above.
P_{O}_{_{—}}_{PUSCH}(j) and α(j) are parameters as defined above, where j=1.

As mentioned above, according to document [1], a TPC command for PUSCH can be included in PDCCH with DCI format 0 or jointly coded with other TPC commands in PDCCH with DCI format 3/3A whose CRC parity bits are scrambled with TPC-PUSCH-RNTI.

However, if a TPC command is received in PDCCH with DCI format 3/3A, there may be a case in which a PUSCH resource assignment is not received for the same subframe in DCI format 0.

If the UE receives a TPC command for PUSCH it shall adjust the uplink power control state accordingly. This requires certain parameters to calculate the limits for accumulation when transmission power has reached the maximum or minimum power.

If the UE receives a TPC command for PUCCH it shall adjust the uplink power control state accordingly. This requires certain parameters to calculate the limits for accumulation.

However, if there is no UL allocation for PUSCH transmission or there is no PUCCH transmission for the given subframe for which the accumulation is set, not all the parameters required for transmit power calculation are present. If it is not checked or checked with incorrect parameters whether maximum/minimum transmission power level limits have been reached or not for uplink power control adjustment state, the following PUSCH transmissions may be sent with invalid transmission power.

### PRIOR ART DOCUMENTS

[1] 3GPP, TS 36.213 V9.3.0 (September 2010); 3^{rd} Generation Partnership Project; Technical Specification Group Radio Access Network; Evolved Universal Terrestrial Radio Access (E-UTRA); Physical layer procedures (Release 9).

### SUMMARY OF THE INVENTION

It is an object of the present invention to provide an apparatus and method and a computer program product for uplink transmission power control in discontinuous data transfer.

According to an aspect of the present invention, there is provided a method, comprising:
calculating, on a processor at a user equipment, a transmission power based on currently used bandwidth, and
checking, on the processor at the user equipment, whether a transmission power limit has been reached based on the calculated transmission power.

According to another aspect of the present invention, there is provided an apparatus, comprising:
at least one processor,
and at least one memory including computer program code,
the at least one memory and the computer program code configured to, with the at least one processor, cause the apparatus at least to perform:
calculating, at a user equipment, a transmission power based on currently used bandwidth, and
checking, at the user equipment, whether a transmission power limit has been reached based on the calculated transmission power.

According to still another aspect of the present invention, there is provided an apparatus comprising:
at least one processor,
and at least one memory including computer program code,
the at least one memory and the computer program code configured to, with the at least one processor, cause the apparatus at least to perform:
calculating a transmission power based on channel format and bit number dependent values, and
checking whether a transmission power limit has been reached based on the calculated transmission power.

### BRIEF DESCRIPTION OF THE DRAWINGS

The above and other objects, features, details and advantages will become more fully apparent from the following detailed description of example embodiments which is to be taken in conjunction with the appended drawings, in which:

FIG. 1 shows a signaling diagram for a method for calculating the transmission power.

FIG. 2 is a diagram illustrating a change of transmission power over time.

FIG. 3 is a diagram illustrating a change of transmission power over time where the transmission power reaches a maximum transmission power.

FIG. 4 is a diagram illustrating a change of transmission power over time where the transmission power reaches a minimum transmission power.

FIG. 5 shows a principle configuration of an example for an apparatus according to certain embodiments of the present invention.

FIG. 6 shows a principle flowchart of an example for a method according to certain embodiments of the present invention.

### DETAILED DESCRIPTION

In the following, embodiments of the present invention are described by referring to general and specific examples of the embodiments. It is to be understood, however, that the description is given by way of example only, and that the described embodiments are by no means to be understood as limiting the present invention thereto.

In the following description of embodiments of the present invention, the present invention is described as being applied to UTRAN/E-UTRAN. However, it is noted that this is merely an example and that the invention is applicable to other radio access technologies using network controlled power adjustment.

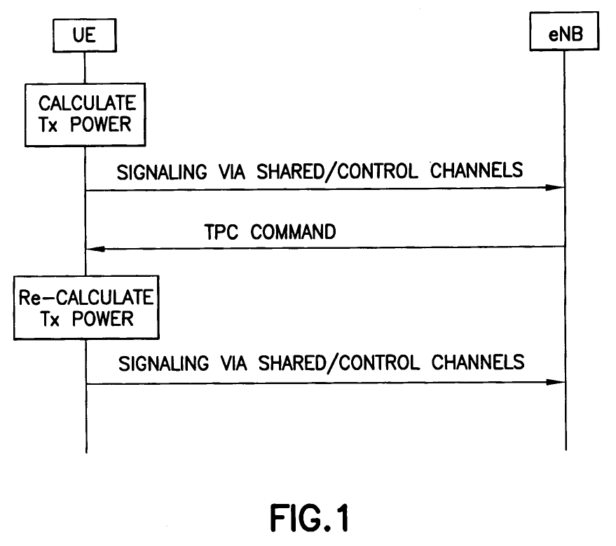

FIG. 1 illustrates a method for calculating a transmission power. As shown in FIG. 1, the UE first calculates the transmission power and uses the calculated transmission power for signaling on shared/control channels, i.e. PUSCH or PUCCH. Additionally, transmission power can be calculated for the Sounding Reference Symbol (SRS) transmission. Then, the base station sends to the UE a TPC command. Based on the TPC command, the UE re-calculates the transmission power and uses the re-calculated transmission power for PUSCH, PUCCH and SRS signaling.

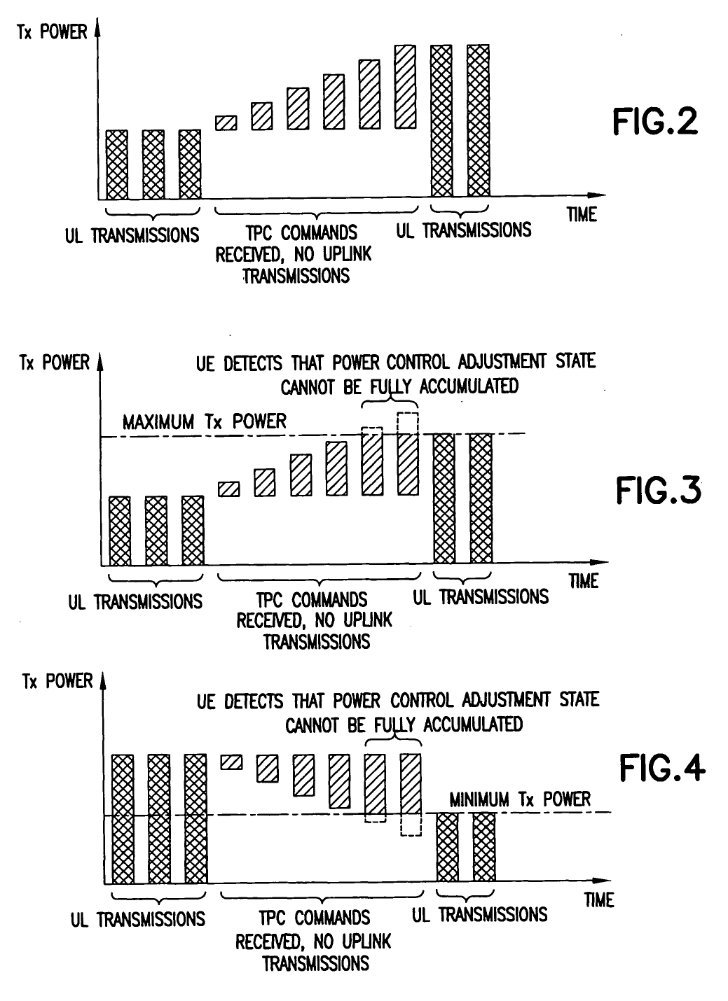

FIG. 2 illustrates the change of the transmission power over time. As shown in FIG. 2, the TPC command is added to the current transmission power and thus, the transmission power raises.

FIG. 3 shows a case, in which the transmission power reaches a maximum transmission power. As is shown in FIG. 3, although the TPC commands are received and should be added to the current transmission power, the TPC commands (i.e. the power control adjustment state) cannot be accumulated to the transmission power, once the maximum transmission power is reached. Thus, TPC commands are not accumulated when power calculation has reached the maximum power limit.

In a similar manner, FIG. 4 shows a case, in which the transmission power reaches a minimum transmission power. As is shown in FIG. 4, although the TPC commands are received and should be added to the current transmission power, the TPC commands (i.e. the power control adjustment state) cannot be accumulated to the transmission power, if the minimum transmission power is reached. Thus, TPC commands are not accumulated when power calculation has reached the minimum power limit.

According to an embodiment of the present invention, in order to check if maximum or minimum transmission power has been reached for PUSCH, which limits the accumulation of the power control adjustment state, as shown in FIGS. 3 and 4, the transmission power for PUSCH can be calculated based on a predefined resource block assignment for currently used bandwidth. The predetermined resource block assignment is, for example, a minimum/maximum resource block assignment.

When checking if maximum power limit is reached, the minimum resource block assignment can be used. Further, when checking if minimum power limit is reached, the maximum resource block assignment can be used.

One option can be to use the previous resource block allocation for the calculation.

Another option would be to use the previously stored PUSCH transmission power with accumulation added from received TPC command.

As described above, the network may send TPC commands for PUSCH in DCI format 3/3A without the uplink resource block allocation in DCI format 0. For example, TPC commands for PUSCH can be based on SRS transmissions. In order to check, if maximum or minimum PUSCH transmission power has been reached according to the above described formula defined in document [1], M_{PUSCH}(i) is needed. However, as mentioned above, there might be cases in which M_{PUSCH}(i) is not received. Thus, there might be a case in which not all parameters for controlling the transmission power are assigned.

According to embodiments of the present invention, there are proposed three methods in order to check whether a minimum or maximum transmission power has been reached.

In the first method, a predefined bandwidth dependent value is used. The value can be for example maximum or minimum value for resource block assignment. That is, when checking if maximum transmission power limit is reached a minimum resource block assignment can be used for example, and when checking if minimum transmission power limit is reached, a maximum resource block assignment can be used for example.

In the second method, the latest resource block assignment for PUSCH is used in the calculation.

In the third method, the latest calculated PUSCH transmission power accumulated with received TPC command is used.

With this invention, a base station can safely update accumulated power control adjustment with DCI formats 3 and 3A without granting uplink allocations to UE. UE can properly limit power control adjustment accumulation so that predicted calculated transmission power does not cross its limits even when resource block allocations are not received.

In the case of PUCCH, there are also proposed three methods in order to check whether a minimum or maximum transmission power has been reached.

In the first method, predefined PUCCH format and bit number dependent values are used. The values can be such that they will result to maximum or minimum value for h and for Δ_{F}_{_{—}}_{PUCCH}(F). That is, when checking if maximum transmission power limit is reached, minimum values for h and Δ_{F}_{_{—}}_{PUCCH}(F) can be used for example, and when checking if minimum transmission power limit is reached, maximum values can be used for example.

In the second method, the latest h and Δ_{F}_{_{—}}_{PUCCH}(F) values for PUCCH in the calculation are used.

In the third method, the latest calculated PUCCH transmission power accumulated with received TPC command is used.

FIG. 5 shows a principle configuration of an example for an apparatus according to certain embodiments of the present invention. One option for implementing this example for an apparatus according to certain embodiments of the present invention would be a component in a handset such as user equipment according to E-UTRAN.

Specifically, as shown in FIG. 5, the example for an apparatus 10 comprises at least one processor 11, and at least one memory 12 including computer program code, the at least one memory and the computer program code configured to, with the at least one processor, cause the apparatus at least to perform calculating a transmission power based on currently used bandwidth, and checking whether a transmission power limit has been reached based on the calculated transmission power. According to another embodiment, the at least one memory and the computer program code are further configured to, with the at least one processor, cause the apparatus to perform calculation a transmission power based on channel format and bit number dependent values.

Additionally, the apparatus may comprise a transmitting unit (not shown) configured to receive a TPC command from a base station and to send various data to the base station.

In the foregoing exemplary description of the apparatus, only the units that are relevant for understanding the principles of the invention have been described using functional blocks. The apparatus may comprise further units that are necessary for its respective operation. However, a description of these units is omitted in this specification. The arrangement of the functional blocks of the devices is not construed to limit the invention, and the functions may be performed by one block or further split into sub-blocks.

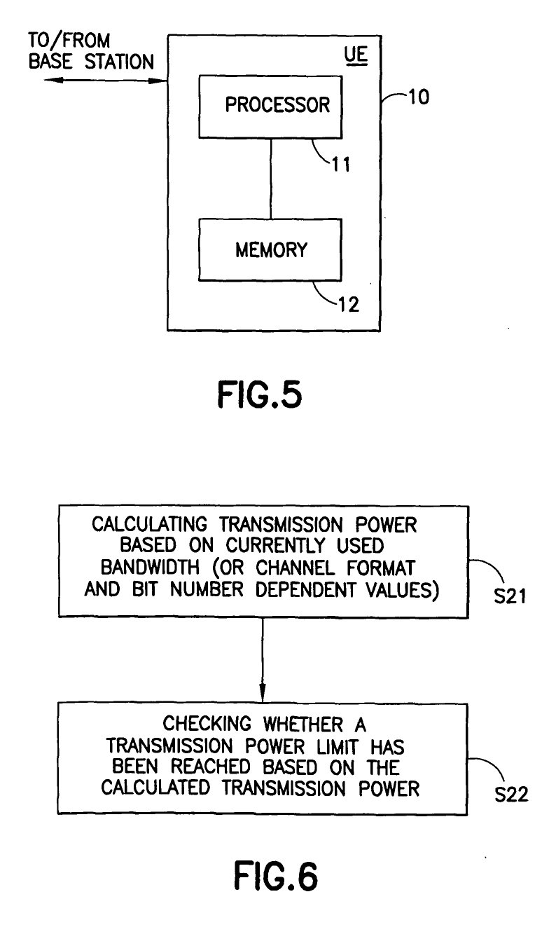

FIG. 6 shows a principle flowchart of an example for a method according to certain embodiments of the present invention. That is, as shown in FIG. 6, this method comprises calculating, at step S21, a transmission power based on currently used bandwidth or based on channel format and bit number dependent values, and checking, at step S22, whether a transmission power limit has been reached based on the calculated transmission power.

Additionally, the method may include receiving (not shown) a TPC command from a base station and sending (not shown) various data to the base station.

One option for performing the example of a method according to certain embodiments of the present invention would be to use the apparatus as described above or a modification thereof which becomes apparent from the embodiments as described above.

For the purpose of the present invention as described herein above, it should be noted that
method steps likely to be implemented as software code portions and being run using a processor or several processors at a user equipment (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses and user equipments, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor or on several processors;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is noted that the embodiments and general and specific examples described above are provided for illustrative purposes only and are in no way intended that the present invention is restricted thereto. Rather, it is the intention that all variations and modifications which fall within the scope of the appended claims are covered.

1. A method, comprising:
calculating, on a processor at a user equipment, a transmission power based on currently used bandwidth, and
checking, on the processor at the user equipment, whether a transmission power limit has been reached based on the calculated transmission power.

2. The method according to claim 1, further comprising
calculating a transmission power based on a predefined resource block assignment, and
checking whether a transmission power limit has been reached based on the transmission power calculated by the calculating unit.

3. The method according to claim 2, further comprising
calculating a minimum transmission power based on a maximum resource block assignment, and
checking whether a minimum transmission power limit has been reached based on the transmission power calculated by the calculating unit.

4. The method according to claim 2, further comprising
calculating a maximum transmission power based on a minimum resource block assignment, and
checking whether a maximum transmission power limit has been reached based on the transmission power calculated by the calculating unit.

5. The method according to claim 1, wherein
the transmission power is calculated based on a previous resource block assignment.

6. The method according to claim 1, wherein
the transmission power is calculated based on a previous calculated transmission power accumulated with a transmission power control command received from a base station.

7. An apparatus, comprising:
at least one processor,
and at least one memory including computer program code,
the at least one memory and the computer program code configured to, with the at least one processor, cause the apparatus at least to perform:
calculating, at a user equipment, a transmission power based on currently used bandwidth, and
checking, at the user equipment, whether a transmission power limit has been reached based on the calculated transmission power.

8. The apparatus according to claim 7, further being caused to perform
calculating a transmission power based on a predefined resource block assignment, and
checking whether a transmission power limit has been reached based on the transmission power calculated by the calculating unit.

9. The apparatus according to claim 8, further being caused to perform
calculating a minimum transmission power based on a maximum resource block assignment, and
checking whether a minimum transmission power limit has been reached based on the transmission power calculated by the calculating unit.

10. The apparatus according to claim 8, further being caused to perform
calculating a maximum transmission power based on a minimum resource block assignment, and
checking whether a maximum transmission power limit has been reached based on the transmission power calculated by the calculating unit.

11. The apparatus according to claims 7, further being caused to perform
calculating the transmission power based on a previous resource block assignment.

12. The apparatus according to claim 7, further being caused to perform
calculating the transmission power based on a previous calculated transmission power accumulated with a transmission power control command received from a base station.

13. An apparatus, comprising:
at least one processor,
and at least one memory including computer program code,
the at least one memory and the computer program code configured to, with the at least one processor, cause the apparatus at least to perform:
calculating a transmission power based on channel format and bit number dependent values, and
checking whether a transmission power limit has been reached based on the calculated transmission power.

14. The apparatus according to claim 13, further being caused to perform
calculating a transmission power based on predefined values dependent on channel format and bit number, and
checking whether a transmission power limit has been reached based on the transmission power calculated by the calculating unit.

15. The apparatus according to claim 14, further being caused to perform
calculating a minimum transmission power based on maximum values dependent on channel format and bit number, and
checking whether a minimum transmission power limit has been reached based on the transmission power calculated by the calculating unit.

16. The apparatus according to claim 14, further being caused to perform
calculating a maximum transmission power based on minimum values dependent on channel format and bit number, and
checking whether a maximum transmission power limit has been reached based on the transmission power calculated by the calculating unit

17. The apparatus according to claim 13, further being caused to perform
calculating the transmission power based on previous channel format and bit number dependent values.

18. The apparatus according to claim 13, further being caused to perform
calculating the transmission power based on a previous calculated transmission power accumulated with a transmission power control command received from a base station.
